(19) United States
(12) Patent Application Publication
(10) Pub. No.: US 2022/0218031 A1
(43) Pub. Date: Jul. 14, 2022

(54) HEATING DEVICE FOR ELECTRIC HEATING SMOKING SET AND ELECTRIC HEATING SMOKING SET

(71) Applicants: Shanhong WANG, Shenzhen, Guangdong (CN); SHENZHEN JIAPIN JIANYI TECHNOLOGY CO., LTD, Shenzhen, Guangdong (CH)

(72) Inventor: Shanhong WANG, Shenzhen, Guangdong (CN)

(21) Appl. No.: 17/610,114

(22) PCT Filed: Apr. 2, 2020
(86) PCT No.: PCT/CN2020/082924

§ 371 Date: Nov. 9, 2021

(30) Foreign Application Priority Data
May 16, 2019 (CN) 201920697691.3

(51) Int. Cl. A24F 40/46; H05B 3/40

(52) U.S. Cl. CPC A24F 40/46; H05B 2203/016; H05B 3/40

(57) ABSTRACT

Provided are a heating device for an electric heating smoking set and an electric heating smoking set. The heating device is composed of a pin-type sleeve (1), a heating body (2), a fixing seat (3), and a lead (4), the pin-type sleeve (1) is of hollow pin-type structure, the heating body (2) is mounted on the fixing seat (3), the heating body (2) and the fixing seat (3) are placed into a cavity of the pin-type sleeve (1), two ends of the heating body (2) are connected to the lead (4) directly or indirectly, and the other end of the lead (4) is connected to a power source or a control device. The heating device made by means of the structure of the pin-type sleeve (1) and the built-in heating body (2) can achieve the aims of reducing thermal loss, rapidly heating and reducing the preheating waiting time.

### FIELD OF THE INVENTION

The present invention relates to a smoking appliance, in particular to a heating device for an electric heating smoking set.

### BACKGROUND OF THE INVENTION

Most of the heating devices used in the existing tobacco electric heating smoking sets are sheet-type or pin-type structures. The heating device is made of ceramics or other materials in the form of a sheet or pin, and one or more conductive paths of heating metal are printed on the surface or inner wall for resistance heating and temperature monitoring.

When the above heating device works, the ceramic substrate absorbs heat. The heat loss is large, and the heating response is slow. As a result, the preheating time of the smoking set is long. The preheating time may be 10 seconds or more. The user needs to wait a long time before smoking.

### SUMMARY OF THE INVENTION

The primary object of the present invention is to provide a heating device for an electric heating smoking set and an electric heating smoking set having the heating device. It can achieve rapid heating and reduce the preheating waiting time.

In order to achieve the foregoing object, a heating device for an electric heating smoking set is provided. The heating device is composed of a pin-type sleeve, a heating body, a fixing seat and a lead. The pin-type sleeve is of hollow pin-type structure. The heating body is mounted to the fixing seat. The heating body and the fixing seat are placed into a cavity of the pin-type sleeve. Two ends of the heating body are directly or indirectly connected to the lead. Another end of the lead is connected to a power source or a control device.

Furthermore, an insulating material with a high thermal conductivity is filled between the heating body and the pin-type sleeve.

Furthermore, the pin-type sleeve is made of a metal, metal alloy or non-metallic material with a high thermal conductivity. The fixing seat is made of a high-temperature resistant insulating material.

Furthermore, the two ends of the heating boy are each directly connected to one lead. After the two leads are connected to the heating body, the two leads extend out of a bottom of the fixing seat.

Furthermore, the pin-type sleeve is an electrical conductor. A top of the heating body is connected to the pin-type sleeve. A bottom of the heating body is connected the lead. Another lead is connected to an outer surface of the pin-type sleeve.

Furthermore, the heating body is in the shape of a straight line, spiral line or straight sheet shape.

Furthermore, the lead is in the shape of a straight line, a curved line or taper.

In order to achieve the foregoing object, an electric heating smoking set is provided. The electric heating smoking set has the foregoing heating device.

By adopting the above technical solution, compared with the prior art, the present invention has the following beneficial effects:

The heating device made by means of the structure of the pin-type sleeve and the built-in heating body can achieve the aims of reducing thermal loss, rapidly heating and reducing the preheating waiting time.

### BRIEF DESCRIPTION OF THE DRAWINGS

FIG. 1 is a perspective view of a heating device for an electric heating smoking set; and

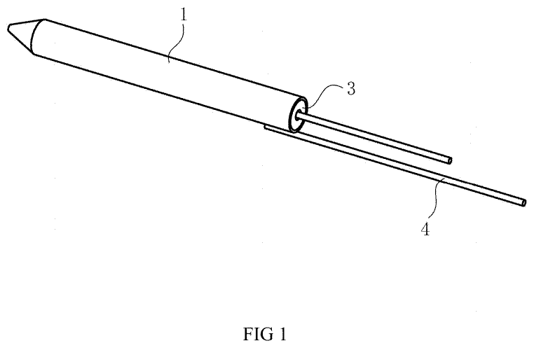

FIG. 2 is an exploded view of a heating device for an electric heating smoking set.

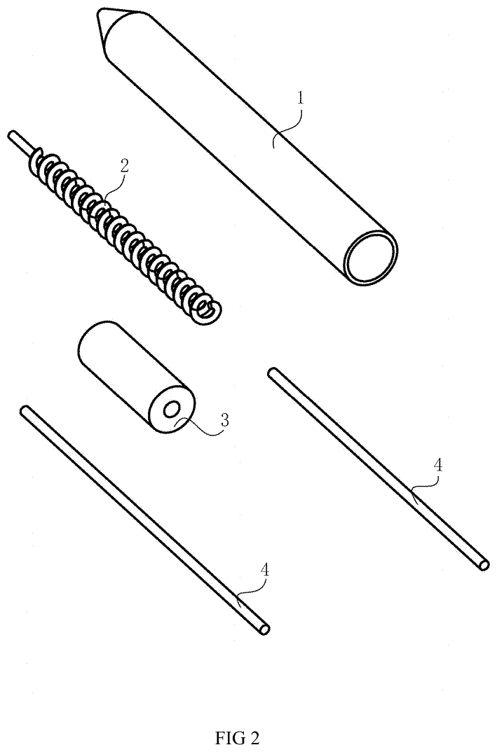

### DESCRIPTION OF THE PREFERRED EMBODIMENTS

Embodiments of the present invention will now be described, by way of example only, with reference to the accompanying drawings. According to the following description, the advantages and features of the present invention will be clearer. It should be noted that the drawings all adopt a very simplified form and precise proportions, which are only used for explaining the purpose of the embodiments of the present invention conveniently and clearly.

The present invention provides a heating device for an electric heating smoking set. The heating device is composed of a pin-type sleeve 1, a heating body 2, a fixing seat 3 and a lead 4. The pin-type sleeve 1 is of hollow pin-type structure made of metal, metal alloy or other materials with a high thermal conductivity. The heating body 2 is mounted to the fixing seat 3. The fixing seat 3 is made of a high-temperature resistant insulating material. The heating body 2 and the fixing seat 3 are placed into a cavity of the pin-type sleeve 1. Two ends of the heating body 2 are directly or indirectly connected to the lead 4 to form two terminals. One end of the lead 4 is directly or indirectly connected to the heating body 2, and the other end of the lead 4 is connected to a power source or a control device. The heating body 2 may be in the shape of a spiral line, straight line, or straight sheet. The lead 4 may be in the shape of a straight line, or may be in the shape of curved line or taper corresponding to the structure of the fixing seat 3 or the pin-type sleeve 1. According to needs, an insulating material with a high thermal conductivity may be filled between the heating body 2 and the pin-type sleeve 1.

In one embodiment, the two ends of the heating boy 2 are each directly connected to one lead 4. After the two leads 4 are connected to the heating body 2, the two leads 4 extend out of the bottom of the fixing seat 3.

In another embodiment, the pin-type sleeve 1 is an electrical conductor with a high thermal conductivity. The heating body 2 is a spiral body. The top of the heating body 2 is connected to the pin-type sleeve 1, and the bottom of the heating body 2 is directly connected one lead 4. The lead 4 extends out of the fixing seat 3. Another lead 4 is connected to the outer surface of the pin-type sleeve 1 and indirectly connected to the heating body 2.

The heating device made by means of the structure of the pin-type sleeve 1 and the built-in heating body 2 can achieve the aims of reducing thermal loss, rapidly heating and reducing the preheating waiting time.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A heating device for an electric heating smoking set, characterized in that, the heating device is composed of a pin-type sleeve (1), a heating body (2), a fixing seat (3) and a lead (4), the pin-type sleeve (1) is of hollow pin-type structure, the heating body (2) is mounted to the fixing seat (3), the heating body (2) and the fixing seat (3) are placed into a cavity of the pin-type sleeve (1), two ends of the heating body (2) are directly or indirectly connected to the lead (4), another end of the lead (4) is connected to a power source or a control device.

2. The heating device as claimed in claim 1, characterized in that, an insulating material with a high thermal conductivity is filled between the heating body (2) and the pin-type sleeve (1).

3. The heating device as claimed in claim 1, characterized in that, the pin-type sleeve (1) is made of a metal, metal alloy or non-metallic material with a high thermal conductivity, and the fixing seat (3) is made of a high-temperature resistant insulating material.

4. The heating device as claimed in claim 1, characterized in that, the two ends of the heating boy (2) are each directly connected to one said lead (4), after the two leads (4) are connected to the heating body (2), the two leads (4) extend out of a bottom of the fixing seat (3).

5. The heating device as claimed in claim 1, characterized in that, the pin-type sleeve (1) is an electrical conductor, a top of the heating body (2) is connected to the pin-type sleeve (1), a bottom of the heating body (2) is connected the lead (4), and another lead (4) is connected to an outer surface of the pin-type sleeve (1).

6. The heating device as claimed in claim 1, characterized in that, the heating body (2) is in the shape of a straight line, spiral line or straight sheet shape.

7. The heating device as claimed in claim 1, characterized in that, the lead (4) is in the shape of a straight line, a curved line or taper.

8. An electric heating smoking set, characterized in that, the electric heating smoking set has the heating device as claimed in any one of claims 1-7.
